(19) United States
(12) Patent Application Publication
(10) Pub. No.: US 2011/0259119 A1
(43) Pub. Date: Oct. 27, 2011

(54) TWO-PHASE FLOW METER

(75) Inventor: Richard N. Steven, Fort Collins, CO (US)

(73) Assignee: McCrometer, Inc, Hemet, CA (US)

(21) Appl. No.: 12/668,906

(22) PCT Filed: Jul. 14, 2008
(86) PCT No.: PCT/US08/69996

§ 371 Date: Apr. 19, 2011

Related U.S. Application Data
(60) Provisional application No. 60/959,427, filed on Jul. 13, 2007.

(51) Int. Cl. G01F 1/34

(52) U.S. Cl. 73/861.42

(57) ABSTRACT

An assembly including conduit for conveying a flowable substance having a gas phase and a liquid phase, and a cone-shaped displacement member including an upstream end and a downstream end. A first flow measurement tap communicates with an area at the upstream end, a second flow measurement tap communicates with an area at the downstream end and a third flow measurement tap communicates with an area downstream of the displacement member. A device determines a first differential pressure value based on a flow measurement taken from any two of the first, second and third flow measurement taps and a second differential pressure value based on a flow measurement taken at one different tap.

### PRIORITY CLAIM

This application is a U.S. National Phase under 35 U.S.C. §371 of International Application No. PCT/US2008/069996, filed Jul. 14, 2008, which claims priority from U.S. Provisional Patent Application No. 60/959,427, filed Jul. 13, 2007.

### FIELD OF THE INVENTION

The present invention relates to fluid flow apparatus and, in particular, to fluid flow meters.

### BACKGROUND

Flow meters are instruments used to measure linear, nonlinear, mass or volumetric flow rate of a liquid or a gas or a mix of liquid and gas flow in many experimental and industrial applications.

Single phase flow meters measure the flow rate of a gas or liquid flowing through a conduit such as a pipeline. One such flow meter is a differential pressure flow meter or DP flow meter.

DP flow meters introduce some obstruction to the pipe flow and measure the change in pressure of the flow between two points in the vicinity of the obstruction. The obstruction is often termed a “primary element” which can be either a constriction formed in the conduit or a structure inserted into the conduit. The primary element can be for example a Venturi constriction, an orifice plate, a wedge, a nozzle or a cone-shaped element. There are other primary element designs used by different differential pressure flow meter manufacturers but fundamentally all such designs operate according to the same physical principles.

Some applications utilize two-phase flow where a single fluid occurs as two different phases (i.e., a gas and a liquid), such as steam and water. The term “two-phase flow” also applies to mixtures of different fluids having different phases, such as air and water, or oil and natural gas.

As an example, two phase flow is employed in large scale power systems. Coal and gas-fired power stations use very large boilers to produce steam for use in turbines. In such cases, pressurized water is passed through heated pipes and it changes to steam as it moves through the pipe. The boiler design requires a detailed understanding of two-phase flow heat-transfer and pressure drop behavior, which is significantly different from the single-phase case. As another example, nuclear reactors use water to remove heat from the reactor core using two-phase flow. Because understanding the fluid flow in such applications is critical, a great deal of study has been performed on the nature of two-phase flow in such cases, so that engineers can design against possible failures in pipework, loss of pressure, and other malfunctions.

As a result, two phase flow meter systems were developed to address the need to measure both phases in two-phase flow applications. One type of system uses two flow meters in series to measure two-phase flow such as two DP flow meters in series in a conduit.

The general idea is that with single phase flow, both meters read the correct gas mass flow within the uncertainties of each meter. With wet gas flow, the liquid content with the gas induces an error in each meters gas flow rate prediction. The single phase gas meters in series wet gas flow meter system relies on the fact that these two gas meters in series will have significantly different reactions to the wet gas flow, i.e. different gas flow rate errors. Then, by suitable mathematical analysis, the two meters erroneous gas flow rate readings can be compared and the unique combination of gas and liquid flow rates causing both these results to be deduced.

Although the fluid flows of the different phases can be measured by the two meter in series systems, these systems are heavier, longer and more expensive than single flow meters.

Accordingly, there is a need for a single flow meter that accurately measures the flow rate of each phase of a two-phase fluid moving through a conduit.

### SUMMARY

The present invention provides an apparatus and method for determining the gas phase flow rate and the liquid phase flow rate for a two-phase fluid flowing through a conduit such as a pipeline using a single, flow meter having a cone-shaped DP flow meter.

In an embodiment, a two-phase fluid flow meter assembly is provided and includes a conduit for conveying a flowable substance having a gas phase and a liquid phase there through in a given direction, where the conduit has a peripheral wall with an interior surface. The flow meter includes a cone-shaped, fluid flow displacement member including an upstream end and a downstream end relative to the direction of fluid flow, where the displacement member is smaller in size than the conduit and having a sloped wall forming a periphery on the member for deflecting the substance to flow through a region defined by the periphery of the displacement member and the interior surface of the conduit.

A first flow measurement tap extends through the wall of the conduit and communicates with an area upstream of the displacement member. A second flow measurement tap extends through the wall of the conduit and through the displacement member, and communicates with an area at the downstream end of the displacement member. A third flow measurement tap extends through the wall of the conduit and communicates with an area downstream of the displacement member. The flow meter includes a device that determines a first differential pressure value based on a flow measurement taken from any two of the first flow measurement tap, the second flow measurement tap and the third flow measurement tap, a second differential pressure value based on a flow measurement taken from a different two of the first flow measurement tap, the second flow measurement tap and the third flow measurement tap, and a third differential pressure value using the determined first and second differential pressure values. The flow meter assembly deteiniines a gas flow rate for the gas phase of the substance and a liquid flow rate for the liquid phase of the substance using the first, second and third differential pressure values.

In another embodiment, a method of determining flow rates of a two-phase fluid using a flow meter including a displacment member positioned within a conduit, a first flow measurement tap positioned upstream from the displacment member, a second flow measurement tap positioned at a downstream end of the displacement member and a third flow measurement tap positioned downstream from the displacement member, includes measuring a pressure of the fluid at each of the first flow measurement tap, the second flow measurement tap and the third flow measurement tap. The next steps are determining a first differential pressure between any two of the first flow measurement tap, the second flow measurement tap and the third flow measurement tap; determining a second differential pressure between any two of the first flow measurement tap, the second flow measurement tap and the third flow measurement tap wherein two flow measurement taps used to determine said second differential pressure are different than said flow measurement taps used to determine said first differential pressure and determining a third differential pressure based on the determined first and second differential pressures. The above determinations are used to determine a traditional meter gas flow rate, determining an expansion meter gas flow rate, determining theta o which is the ratio of the traditional meter gas flow rate to the expansion meter gas flow rate. The Lockhart Martinelli equation is substituted into the traditional cone meter wet gas correlation or an expansion cone meter wet gas correlation. A number of iterations are performed to determine m_{g}, X_{LM} and F_{rg}. From this information, the next step is to determine the liquid flow rate for the two-phase fluid using X_{LM}.

It is an object of the present invention to provide a flow meter that can measure the flow rates of the gas and liquid phases of a two-phase fluid flowing through a conduit.

Another object of the present invention is to provide a two-phase flow meter that is compact, light and less expensive than existing flow meters used to measure two-phase flow.

These and other objects and advantages of the invention will become apparent to those of reasonable of skill in the art from the following detailed description, as considered in conjunction with the accompanying drawings.

### BRIEF DESCRIPTION OF THE DRAWINGS

FIG. 1 is a fragmentary side view of an embodiment of the two-phase flow meter of the invention using single phase notation.

### DETAILED DESCRIPTION

The following is a detailed description of preferred embodiments of the invention presently contemplated by the inventors to be the best mode of carrying out the invention. Modifications and changes therein will become apparent to persons of reasonable skill in the art as the description proceeds.

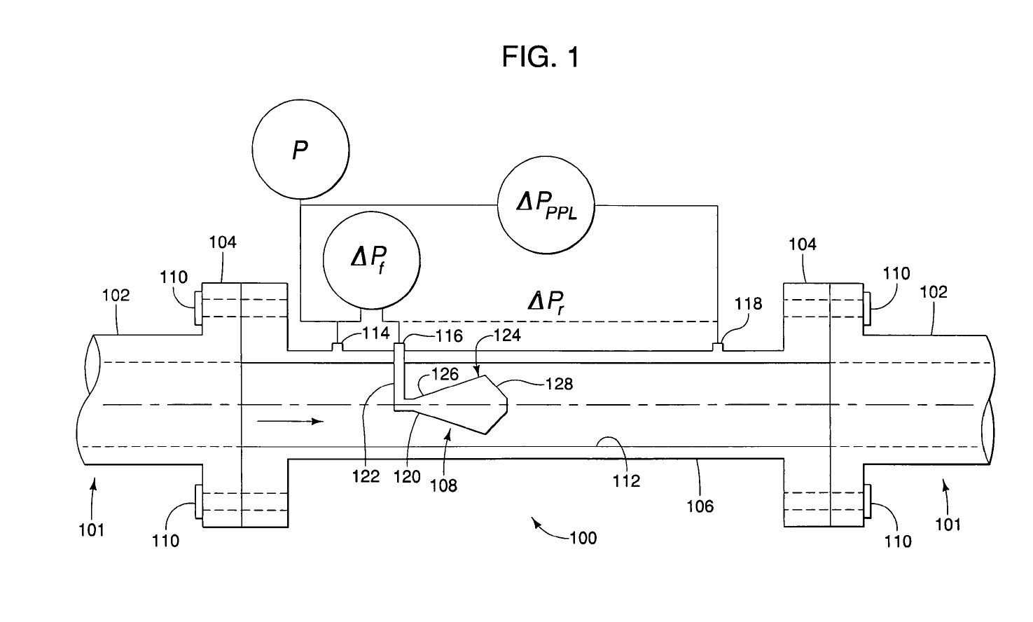

Referring to FIG. 1, a two-phase fluid flow meter of the invention, indicated generally as 100, is adapted to be installed in a pipeline or other fluid flow conduit which is depicted as being comprised of pipe sections 102 having bolting flanges 104 at its ends. It should be appreciated that the pipe sections can be connected to the meter using any suitable connectors or connection methods. The flow meter 100 is comprised of a meter body or conduit section 106 and a fluid flow displacement device 108 mounted coaxially within the body. The meter body 106 comprises, in essence, a section of pipe or conduit adapted to be bolted or otherwise secured between two sections of pipe, for example, between the flanges 104 of the illustrated pipe sections 102. The meter body 106 illustrated, by way of example, is of the so called wafer design and is simply confined between the flanges 104 and centered or axially aligned with the pipe sections 102 by means of circumferentially spaced bolts 110 extending between and connecting the flanges. However, the conduit section 106 may be of any suitable pipe configuration, such as a flanged section or welded section.

The conduit section 106 has an internal bore or through hole 112 which in use comprises a part of, and constitutes a continuation of the path of fluid flow through the pipeline 101. As indicated by the arrow, the direction of fluid flow is from left to right as viewed in the drawings. The pipeline 101 and conduit section 106 are usually cylindrical and the bore 112 is usually, though not always, of the same internal cross section and size as the pipe sections 102.

Longitudinally spaced flow measurement taps 114, 116 and 118 extend radially through the conduit section or body 106 at locations and for purposes to be described.

The displacement device 108 includes a displacement member 120 and a support or mount 122.

The displacement member 120 is comprised of a body, usually cylindrical, which has a major transverse diameter or dimension at edge 124 and two oppositely facing, usually conical, sloped walls 126 and 128 which face, respectively, in the upstream and downstream directions in the meter body and which taper symmetrically inward toward the axis of the body. Except as hereinafter described, the displacement member 120 has essentially the same physical characteristics and functions in essentially the same manner as the flow displacement members utilized in the “V-CONE” devices available from McCrometer Inc. and those described in U.S. Pate. Nos. 4,638,672, 4,812,049, 5,363,699 and 5,814,738, the disclosures of which are incorporated herein by reference, as though here set forth in full. The body may be solid or hollow, and if hollow, may be open or closed at its upstream or forward end 130.

As described in the prior patents, the displacement member 120 is of a smaller size than the bore 112 in the conduit section 106 and is mounted coaxially within the bore normal to the direction of fluid flow and with the sloped walls 126 and 128 spaced symmetrically inward from the interior or inner surface of the wall of the conduit. The larger and contiguous ends of the sloped walls are of the same size and shape and define at their juncture a sharp peripheral edge 124, the plane of which lies normal to the direction of fluid flow. The upstream wall 126 is longer than the downstream wall 128 and preferably tapers inwardly to a small diameter at its upstream end.

As fluid enters the inlet or upstream end of the conduit 106, the fluid is displaced or deflected by the upstream wall 126 of the displacement member 120 into an annular region of progressively decreasing cross-sectional area, to a minimum area at the plane of the peripheral edge 124. The fluid then flows into an annular region of progressively increasing area as defined by the downstream wall 128.

The downstream wall 128 is, in addition, effective to optimize the return velocity of the fluid as it returns to free stream conditions in the conduit downstream from the member.

The upstream or first flow measurement tap 114 measures the pressure of the fluid at that point, which facilitates determination of one or more fluid flow conditions upstream from the edge 124 of the displacement member 120. A downstream or second flow measurement tap 116 measures the pressure axially of the conduit at the downstream face of the displacement member 120. A third flow measurement tap 118 is positioned downstream from the displacement member 120 to measure the pressure of the fluid at that point.

The three flow measurement taps 114, 116 and 118 are connected with suitable flow measurement instrumentation known in the art in order to provide a read out of the pressures at those points in the conduit.

Referring to FIG. 1, the two-phase flow meter 100 (a DP flow meter with a cone-shaped primary element) with standard upstream pressure and upstream to cone differential pressure readings is shown with differential pressure readings ΔPₜ, ΔP_{PPL} and ΔPᵣ. Equation (1) shows the relationship between these differential pressures:

ΔPₜ=ΔPᵣ+ΔP_{PPL} (1)

Therefore, determining any two of the differential pressures allows the third differential pressure to be determined.

The two-phase flow meter (V-Cone meter wet gas meter) operates by utilizing standard wet gas correction factors as can be developed for all DP meters when tested with wet gas flows as shown in equation (2):

$$OR = {( \frac{{m}_{g , Apparent}}{{m}_{g}} )}_{Traditional} = f ( {X}_{LM ,} \frac{{ρ}_{g}}{{ρ}_{l}} , {Fr}_{g} ) \qquad ( 2 )$$

The traditional issue with equation (2) is that there are two unknowns. That is, the Lockhart Martinelli parameter (X_{LM}) is determined from equation (3) as follows:

$${X}_{LM} = \sqrt{\frac{Superficial Liquid Inertia}{Superficial Gas Inertia}} = \frac{{m}_{l}}{{m}_{g}} \sqrt{\frac{{ρ}_{g}}{{ρ}_{l}}} \qquad ( 3 )$$

and the gas densiometric Froude number (Fr_{g}) determined equation (4):

$$\begin{matrix}{Fr}_{g} = \sqrt{\frac{Superficial Gas Inertia}{Liquid Gravity Force}} \\ = \frac{{U}_{sg}}{\sqrt{gD}} \sqrt{\frac{{ρ}_{g}}{{ρ}_{l} - {ρ}_{g}}} \\ = \frac{{m}_{g}}{A \sqrt{gD}} \sqrt{\frac{1}{{ρ}_{g} ( {ρ}_{l} - {ρ}_{g} )}}\end{matrix} \qquad ( 4 )$$

Equation (2) has two unknowns, i.e. the gas mass flow rate and the liquid mass flow rate. If the X_{LM} is known, it can be substituted with equation (4) into equation (2) and therefore makes the equation solvable.

The major issue in industry is how to determine X_{LM}. There is a rudimentary method to predict X_{LM} using three pressure taps on a DP meter. According to this method, the pressure loss ratio is found to be dependent on the gas to liquid density ratio, the Lockhart Martinelli parameter and the gas densiometric Froude number. Hence, a correlation can be made that relates the Lockhart Martinelli parameter to the gas to liquid density ratio (known), the gas densiometric Froude number (where the only unknown is the gas mass flow rate) and some particular meter parameter which is known or is solely a function of the gas mass flow rate. The particular expression for Lockhart Martinelli can be substituted into the main DP meter wet gas correlation, i.e., equation (2), to determine the gas mass flow rate. Equation (3) is then used to find the liquid mass flow rate. The present invention is an improvement of this method.

The standard V-Cone meter gas flow equation will give a flow prediction for the case of two-phase wet gas flow. However, the fact that the fluid is a wet gas means that the measured differential pressure is not that of the gas flowing alone (ΔP_{g}), but that of the wet gas (ΔPₜₚ). Therefore, an erroneous (or “apparent”) gas mass flow rate is predicted by equation (5) (by iteration if the discharge coefficient is a function of the Reynolds number) as follows:

(m_{g,Apparent})_{Converging}=EAₜεₜₚC_{dtp}\sqrt{2ρΔPₜₚ} (5)

Likewise, the expansion/diverging section flow equation (6) below will give a flow prediction for the case of two-phase/wet gas flow. However, the fact that the flow is a wet gas means that the measured differential pressure is not that of the gas flowing alone (ΔPᵣ) but that of the wet gas (ΔPₜₚ*). Therefore, an erroneous or “apparent” gas mass flow rate is predicted by equation (6) (by iteration if the expansion coefficient is a function of Reynolds number):

(m_{g}_{_{Apparent}})_{Diverging}=EAₜKₜₚ*\sqrt{2ρΔPₜₚ*} (6)

The methodology to predict the gas and liquid mass flow rates simultaneously from these two DP meter equations is as follows.

Let theta ø be the ratio of the traditional or converging DP meter over-reading (OR) to the expansion or diverging DP meter over-reading (OR′). Note that, when assuming no significant phase change of a two-phase fluid flow through a DP meter, the gas mass flow is the same for both the converging and diverging meter sections and hence theta is also the ratio of the converging DP meters uncorrected gas flow rate prediction to the diverging DP meters uncorrected gas flow rate prediction as follows:

$$φ = \frac{OR}{{OR}^{′}} = \frac{{( \frac{{m}_{g , Apparent}}{{m}_{g}} )}_{Converging}}{{( \frac{{m}_{g , Apparent}}{{m}_{g}} )}_{Diverging}} = \frac{{( {m}_{g , Apparent} )}_{Converging}}{{( {m}_{g , Apparent} )}_{Diverging}} \qquad ( 7 )$$

Theta is therefore known by the flow meter user. It is simply the ratio of the two DP meter equation gas flow rate predictions with no wet gas corrections applied. It has been previously shown that these over-readings are both functions of the Lockhart Martinelli parameter, gas to liquid density ratio and gas densiometric Froude number. Therefore, theta is also a function of Lockhart Martinelli parameter, gas to liquid density ratio and gas densiometric Froude number.

When plotting theta vs. the Lockhart Martinelli parameter, the curve is therefore dependent on the gas to liquid density ratio and the gas densiometric Fronde number. As in dry gas both the converging and diverging meters should give the same correct gas mass flow rate (ignoring the single phase uncertainties). For a dry gas (i.e. X_{LM}=0), theta should be unity.

(φ−1)=(#C)\sqrt{X_{LM}} (8)

where #C is an experimentally derived function of the gas to liquid density ratio and gas densiometric Froude number. Or, a more generic form could be used:

φ−1=(#A)X_{LM}^{#B} (9)

where #A is an experimentally derived function of the gas to liquid density ratio and gas densiometric Froude number and #B is a experimentally derived constant. Note that equation (8) is equation (9) for the special case of #B=½ (when #A=#C are equal).

Fitting each set pair of fixed gas to liquid density ratio and gas densiometric Froude number combination wet gas data sets (for a particular meter) to equation (9) allows a value for #B to be determined. For this value of #B, the #A parameters can be plotted against the gas to liquid density ratio and gas densiometric Froude number. Software such as, TableCurve 3D gives a surface fit, i.e. function “g” where:

$$\# A = g ( \frac{{ρ}_{g}}{{ρ}_{l}} , {Fr}_{g} ) \qquad ( 10 )$$

Substituting equation (10) into equation (9) gives:

$$φ - 1 = ( g ( \frac{{ρ}_{g}}{{ρ}_{l}} , {Fr}_{g} ) ) {X}_{LM}^{\# B} \qquad ( 11 )$$

Note, that equation (11) can be re-arranged to separate the Lockhart Martinelli parameter:

$${X}_{LM} = {( \frac{( φ - 1 )}{g ( \frac{{ρ}_{g}}{{ρ}_{l}} , {Fr}_{g} )} )}^{\frac{1}{\# B}} \qquad ( 12 )$$

Also note that theta o is known from the converging and diverging meter readings, #B is an experimentally derived (and hence known) constant value, and the gas to liquid density ratio is known as the system assumes the meter users know the fluid properties and the pressure and temperature of the flow. This means that the only unknown in the right hand side of equation (12) is the gas densiometric Froude number, Fr_{g}. Equation (13) below indicates that the only unknown in the gas densiometric Froude number term is the gas mass flow rate. Note that this methodology described above are based on the excellent fit of the data to equation (8). This is an example and there are other acceptable fits of the data.

$$\begin{matrix}{Fr}_{g} = \sqrt{\frac{Superficial Gas Inertia}{Liquid Gravity Force}} \\ = \frac{{U}_{sg}}{\sqrt{gD}} \sqrt{\frac{{ρ}_{g}}{{ρ}_{l} - {ρ}_{g}}} \\ = \frac{{m}_{g}}{A \sqrt{gD}} \sqrt{\frac{1}{{ρ}_{g} ( {ρ}_{l} - {ρ}_{g} )}}\end{matrix} \qquad ( 13 )$$

Hence, it is found that equation (12) can be written as:

$${X}_{LM} = {( \frac{( φ - 1 )}{g ( \frac{{ρ}_{g}}{{ρ}_{l}} , {Fr}_{g} )} )}^{\frac{1}{\# B}} = h ( {m}_{g} ) \qquad ( 14 )$$

where the function “h” is the resulting equation from expressing the entire expression of equation (12) as a function of gas mass flow rate, mg. The Lockhart Martinelli parameter is now expressed in terms of gas mass flow rate and other known parameters. That is, the liquid mass flow rate term has been removed. Equation (14) can now be substituted into equation (15) below to give one equation with one unknown, the gas mass flow rate, as follows:

$$\begin{matrix}{( \frac{{m}_{g , Apparent}}{{m}_{g}} )}_{Converging} = f ( {X}_{LM ,} \frac{{ρ}_{g}}{{ρ}_{l}} , {Fr}_{g} ) \\ = f ( {( \frac{( φ - 1 )}{g ( \frac{{ρ}_{g}}{{ρ}_{l}} , {Fr}_{g} )} )}^{\frac{1}{\# B}} , \frac{{ρ}_{g}}{{ρ}_{l}} , {Fr}_{g} )\end{matrix} \qquad ( 15 )$$

Equation (15) is reconfigured to be:

$${( {m}_{g , Apparent} )}_{Converging} - [ {m}_{g}^{*} ( f ( {( \frac{φ - 1}{g ( \frac{{ρ}_{g}}{{ρ}_{l}} , \frac{{m}_{g}}{A \sqrt{gD}} \sqrt{\frac{1}{{ρ}_{g} ( {ρ}_{l} - {ρ}_{g} )}} )} )}^{\frac{1}{\# B}} ) , \frac{{ρ}_{g}}{{ρ}_{l}} , \frac{{m}_{g}}{A \sqrt{gD}} \sqrt{\frac{1}{{ρ}_{g} ( {ρ}_{l} - {ρ}_{g} )}} ) ] = 0 \qquad ( 16 )$$

The result of an iteration on m_{g} provides a prediction of the gas mass flow rate, m_{g}. No liquid mass flow rate or any form of liquid to gas flow rate ratio values were required to be known as inputs. The value of theta, ø, replaces the requirement for the liquid flow rate information.

Once the iteration of Equation (16) is complete and a gas mass flow rate prediction has been obtained, a bi-product of the iteration is a Lockhart Martinelli parameter prediction from equation (14). Here then, we have the ability to predict an associated liquid mass flow rate through equation (17) rearranged to separate the liquid mass flow rate, m₁.

$${m}_{l} = {X}_{LM} * {m}_{g} * \sqrt{\frac{{ρ}_{l}}{{ρ}_{g}}} \qquad ( 17 )$$

The following paragraphs describe a method to predict the gas and liquid mass flow rates of a two-phase or wet gas flow from the use of a stand alone standard V-Cone meter with a downstream pressure tapping.

Experimental data shows that the cone meter expansion flow equation has a smaller wet gas over-reading than the converging or traditional cone meter flow equation.

$$φ = \frac{OR}{{OR}^{′}} = \frac{{( \frac{{m}_{g , Apparent}}{{m}_{g}} )}_{Converging}}{{( \frac{{m}_{g , Apparent}}{{m}_{g}} )}_{Diverging}} = \frac{{( {m}_{g , Apparent} )}_{Converging}}{{( {m}_{g , Apparent} )}_{Diverging}} \geq 1 \qquad ( 18 )$$

If the flow is a dry gas then ø=1, and if the flow is a two-phase or wet gas flow. ø>1. Note, that it is not of course practical to assume that both metering methods embedded in any DP meter geometry will operate with no uncertainty in single phase flow. That is they will both independently give dry gas flow rate predictions that are both very close to the actual gas mass flow rate (i.e., within the small dry gas uncertainty limits associated with each independent flow equation) but not exactly the same as each other. If a dry gas or single phase flow gives the following result:

(m_{g})_{Converging}<(m_{g})_{Diverging} (19)

because of the associated flow equation uncertainties, in this case, a result of ø<1 be found in practice. In this case, theta will be close to unity, e.g. ø=0.99. In these cases the V-Cone meter wet gas flow program would set ø<1 to ø=1 by default thereby finding the Lockhart Martinelli parameter to be zero through equation (14). Similarly, the dry gas uncertainties could cause the result:

(m_{g})_{Converging}>(m_{g})_{Diverging} (20)

If the flow is dry then ø>1 (although it will be a small value such as ø=1.01) and equation (14) will suggest through the iteration of equation (16) a false wet gas result. However, the Lockhart Martinelli parameter and liquid mass flow rate prediction would be very small and thereby the false correction of the gas flow reading would be very small.

In practice, any Lockhart Martinelli parameter reading of say, X_{LM}<0.02, would be defaulted by the flow program to a dry gas or “below the sensitivity of the instrumentation” and approximate dry gas flow.

Another point of interest is that the basic obvious route to solving the liquid and gas flow rates using the traditional (converging) and expansion (diverging) meters individual wet gas correlations is to solve the two equations simultaneously to solve the two unknowns, the liquid and gas mass flow rates. However, this methodology is known to be a problem to industry because it resulted in either two solutions, one true and one false, or no solution at all (due to the size of the uncertainty bands overlapping). This present methodology avoids these problems in that there is no scope for a false convergence or for the methodology to give no solution.

The ratio of the converging and diverging meter uncorrected/apparent gas flow rate predictions produce a Lockhart Martinelli parameter prediction. This then is substituted into the main converging DP meter wet gas correlation or alternatively, the expansion DP meter wet gas correlation thereby giving a reasonable gas mass flow rate prediction every time. Furthermore, the standard wet gas correlation is relatively insensitive to uncertainties in the Lockhart Martinelli parameter prediction method compared to the sensitivities of directly combining the converging and diverging meter wet gas correlations directly. That is, the combination of each of the wet gas correction factors for the converging and diverging meter systems involves combining significant uncertainties and this leads to a poor final result. The present method reduces the uncertainty considerably. Therefore, the present method offers two improvements over existing methods, (1) a guaranteed result (instead of the occasional “no result”) and (2) a more accurate result.

The above V-Cone meter wet gas meter concept was primarily developed and checked against the NEL 6″, 0.75 beta data and the CEESI 4″, 0.75 beta data as it was found that the 0.75 beta ratio V-Cone meter had the best wet gas flow performance. Therefore, 0.75 beta was the meter developed as a V-Cone meter wet gas meter. It is contemplated that meters having other beta values could be manufactured.

The first successful wet gas V-Cone meter was found by the above described manipulation of the NEL6 0.75 beta ratio meter. However, it was found that whereas the CEESI4 0.75 beta wet gas data fit the NEL based standard/converging V-Cone meter 0.75 beta wet gas correlation well. The fit data (i.e. function “g” in equation (12)) was different for NEL and CEESI data sets. Thus, different meters have been tested and worked successfully and has been calibrated individually.

That is, both NEL and CEESI 0.75 beta ratio V-Cone test meters were successfully turned into wet gas meters by the above general method but the meters tested at TEL and CEESI gave data that fitted different functions “g” as shown in equation (12) above.

Another issue is that with increasing gas densiometric Froude numbers and gas to liquid density ratios, the value of theta should theoretically reduce towards unity. Both of these parameters increasing indicates a higher gas dynamic pressure in a wet gas flow and hence a larger driving force on the liquid flow. This in turn means for a set gas to liquid mass flow rate the liquid will become increasingly more entrained in the gas flow. This means that as the gas to liquid density ratio and gas densiometric Froude number increases the flow tends to homogenous flow, i.e. a perfectly dispersed atomised flow. This then, is pseudo-single phase flow. Single phase flow of course registers the only possible result of:

(m_{g})_{Converging}=(m_{g})_{Diverging} (21)

within the uncertainty limitations of the two meter systems. Here then, for a suitably high gas dynamic pressure a wet gas flow through the V-Cone wet gas meter will show no significant difference between the metering systems (i.e., ø≈1). That is not to say the meter systems each give the correct gas mass flow rate. They would not, but they both have the same wet gas error predicted by the homogenous model. At this condition, any pair of meters in series acting as a wet gas meter system, including the V-Cone wet gas meter fails to produce a result.

There is a difference in how different DP meters react to wet gas flows. Some primary element designs resist having an over-reading that tends to the homogenous model until higher gas dynamic pressures (i.e., higher gas to liquid densities and gas densiometric Froude numbers) than others. For example, at a set gas to liquid density ratio it takes a higher gas densiometric Froude number to make an orifice plate meter's wet gas over-reading tend towards the homogenous flow prediction than a Venturi meter. A standard V-Cone meter has a response that is between the orifice and Venturi meters.

Using the traditional generic analysis used by the industry for any meter, there is an issue for the prediction of the X_{LM} to be insensitive to flow rate values greater than 0.15. The V-Cone wet gas meter has a loss of sensitivity at X_{LM}>0.15 which is less extreme than other existing meters. That is, the V-Cone wet gas meter parameter theta o appears to be more sensitive to varying Lockhart Martinelli parameter at X_{LM}>0.15 than the Venturi meters pressure loss ratio.

Most significantly, with fitting, perhaps such as by a blind fit using the software packages TableCurve 2D and TableCurve 3D, it was found that the following relationship was applicable for a two-phase flow in a flow meter with a convergent displacement member with A, B, and C understood as fitted functional parameters based on gas to liquid density ratios for a convergent meter

$$OR = \sqrt{\frac{Δ {P}_{tp}}{Δ {P}_{g}}} = \frac{1 + AX + {BFr}_{g}}{1 + CX + {BFr}_{g}} \qquad ( 22 )$$

This relationship can thus be used to predict a corrected two-phase flow for a flow meter using a convergent core displacement member. Similarly, for a divergent displacement member, it was found that the following relationship was applicable for a two-phase flow in a flow meter with a divergent displacement member with A′, B′, and C′ understood as fitted functional parameters based on gas to liquid density ratios for a divergent meter:

$${OR}^{*} = \sqrt{\frac{Δ {P}_{tp}^{*}}{Δ {P}_{g}^{*}}} = \frac{1 + {A}^{′} X + {B}^{′} {Fr}_{g}}{1 + {C}^{′} X + {B}^{′} {Fr}_{g}} \qquad ( 23 )$$

Each of these two relationships can thus be used to predict a corrected two-phase flow depending on whether there is a convergent or divergent core displacement member.

For the specific case of metering a two-phase, wet gas or two-phase flow with a DP meter having a cone type primary element, and a downstream tapping placed anywhere downstream of the primary element, the above single phase art of two independent flow equations that exist for DP meters (i.e., the converging and expansion flow equations) can be applied in conjunction with the mathematical analysis of two dissimilar independent DP meters in series with two phase, wet gas or two-phase flow, to create a unique and novel stand alone wet gas flow meter system such as the present invention. Such a system has the advantage of being capable of metering the flow of both phases without the need for two independent DP meters in series and is therefore shorter, lighter, more compact and as a consequence more economical that existing systems.

The objects and advantages of the invention have thus been shown to be achieved in a convenient, economical, practical and facile manner.

While presently preferred embodiments of the invention have been herein illustrated and described, it is to be appreciated that various changes, rearrangements and modifications may be made therein without departing from the scope of the invention as defined by the appended claims.

1. A two-phase fluid flow convergent displacement differential pressure flow meter assembly comprising:
a conduit for conveying a flowable substance having a gas phase and a liquid phase there through in a given direction, said conduit having a peripheral wall with an interior surface;
a cone-shaped, fluid flow convergent displacement member including an upstream end and a downstream end relative to the direction of fluid flow, said member being of smaller size than said conduit and having a sloped wall forming a periphery on said member for deflecting said substance to flow through a region defined by said periphery of said displacement member and said interior surface of said conduit;
a first pressure measurement tap extending through the wall of said conduit and communicating with an area upstream of the displacement member;
a second pressure measurement tap extending through the wall of said conduit and through the displacement member, and communicating with an area at said downstream end of said displacement member;
a third pressure measurement tap extending through the wall of said conduit and communicating with an area downstream of the displacement member;
means for determining a first differential pressure value based on a pressure measurement taken from said first pressure measurement tap, and said second pressure measurement tap;
means for determining a second differential pressure value based on a pressure measurement taken from said second pressure measurement tap and said third pressure measurement tap;
and
means for determining a gas flow rate for the gas phase of said substance and a liquid flow rate for the liquid phase of said substance using said first and second differential pressure values in a manner that applies the relationship:
$${m}_{l} = {X}_{LM} ⋆ {m}_{g} ⋆ \sqrt{\frac{{ρ}_{l}}{{ρ}_{g}}}$$
where X_{LM} is represented by the relationship:
$${X}_{LM} = {( \frac{( φ - 1 )}{g ( \frac{{ρ}_{g}}{{ρ}_{l}} , {Fr}_{g} )} )}^{\frac{1}{\# B}}$$
with g determined by iteratively surface fitting the gas to liquid density ratio for the specific meter involved against Fr_{g} as represented by the relationship:
$${Fr}_{g} \begin{matrix}= \sqrt{\frac{Superficial Gas Inertia}{Liquid Gravity Force}} \\ = \frac{{U}_{sg}}{\sqrt{gD}} \sqrt{\frac{{ρ}_{g}}{{ρ}_{l} - {ρ}_{g}}} \\ = \frac{{m}_{g}}{A \sqrt{gD}} \sqrt{\frac{1}{{ρ}_{g} ( {ρ}_{l} - {ρ}_{g} )}}\end{matrix}$$
with theta φ represented by the relationship:
$$φ = \frac{OR}{{OR}^{′}} = \frac{{( \frac{{m}_{g , Apparent}}{{m}_{g}} )}_{Converging}}{{( \frac{{m}_{g , Apparent}}{{m}_{g}} )}_{Diverging}} = \frac{{( {m}_{g , Apparent} )}_{Converging}}{{( {m}_{g , Apparent} )}_{Diverging}} \geq 1$$
m_{g Converging} resented by the relationship:
(m_{g,Apparent})_{Converging}=EAₜεₜₚC_{dtp}\sqrt{2ρΔPₜₚ}
and m_{g Diverging} resented b the relationship:
(m_{g Apparent})_{Diverging}=EAₜKₜₚ*\sqrt{2ρΔPₜₚ*}
each use to then substitute in X_{LM} to the traditional cone meter wet gas correlation as expressed by the relationship:
$$OR = \sqrt{\frac{Δ {P}_{tp}}{Δ {P}_{g}}} = \frac{1 + AX + {BFr}_{g}}{1 + CX + {BFr}_{g}} .$$

2. (canceled)

3. The flow meter assembly of claim 1, wherein said third flow measurement tap extends through said conduit at an area that is at least four diameters downstream from said displacement member.

4. The flow meter assembly of claim 1, wherein said third flow measurement tap extends through said conduit at an area that is six diameters downstream from said displacement member.

5. The flow meter assembly of claim 1, further comprising a support extending through said conduit that mounts said displacement member to said conduit and holds said displacement member in position in the fluid flow.

6. A method of determining flow rates of a two-phase fluid using a convergent displacement differential pressure flow meter including a cone-shaped convergent displacment member positioned within a conduit, a first pressure measurement tap positioned upstream from the cone-shaped displacement member, a second pressure measurement tap positioned at a downstream end of the cone-shaped displacement member and a third pressure measurement tap positioned downstream from the cone-shaped displacement member, said method comprising:
measuring a pressure of the fluid at each of the first pressure measurement tap, the second pressure measurement tap and the third pressure measurement tap;
determining a first differential pressure between the first pressure measurement tap and the second pressure measurement tap;
determining a second differential pressure between the second pressure measurement tap and the third pressure measurement tap wherein two flow measurement taps used to determine said second differential pressure are different than said two flow measurement taps used to determine said first differential pressure;
determining a gas flow rate for the gas phase of said substance and a liquid flow rate for the liquid phase of said substance using said first, and second differential pressure values in a manner that applies the relationship:
$${m}_{l} = {X}_{LM} * {m}_{g} * \sqrt{\frac{{ρ}_{l}}{{ρ}_{g}}}$$
where X_{LM} is represented by the relationship:
$${X}_{LM} = {( \frac{( φ - 1 )}{g ( \frac{{ρ}_{g}}{{ρ}_{l}} , {Fr}_{g} )} )}^{\frac{1}{\# B}}$$
with g determined by iteratively surface fitting the gas to liquid density ratio for the specific meter involved against Fr_{g} as represented by the relationship:
$$\begin{matrix}{Fr}_{g} = \sqrt{\frac{Superficial Gas Inertia}{Liquid Gravity Force}} \\ = \frac{{U}_{sg}}{\sqrt{gD}} \sqrt{\frac{{ρ}_{g}}{{ρ}_{l} - {ρ}_{g}}} \\ = \frac{{m}_{g}}{A \sqrt{gD}} \sqrt{\frac{1}{{ρ}_{g} ( {ρ}_{l} - {ρ}_{g} )}}\end{matrix}$$
with theta φ represented by the relationship:
$$\begin{matrix}φ = \frac{OR}{{OR}^{′}} \\ = \frac{{( \frac{{m}_{g , Apparent}}{{m}_{g}} )}_{Converging}}{{( \frac{{m}_{g , Apparent}}{{m}_{g}} )}_{Diverging}} \\ = \frac{{( {m}_{g , Apparent} )}_{Converging}}{{( {m}_{g , Apparent} )}_{Diverging}} \geq 1\end{matrix}$$
m_{g Converging} resented by the relationship:
(m_{g,Apparent})_{Converging}=EAₜεₜₚC_{dtp}\sqrt{2ρΔPₜₚ}
and m_{g Diverging} represented by the relationship:
(m_{g Apparent})_{Diverging}=EAₜKₜₚ*\sqrt{2ρΔPₜₚ*}
each use to then substitute in X_{LM} to the traditional cone meter wet gas correlation as expressed by the relationship:
$$OR = \sqrt{\frac{Δ {P}_{tp}}{Δ {P}_{g}}} = \frac{1 + AX + {BFr}_{g}}{1 + CX + {BFr}_{g}} .$$

7. (canceled)

8. (canceled)

9. (canceled)

10. (canceled)

11. (canceled)

12. (canceled)

13. (canceled)

14. A two-phase fluid flow divergent displacement differential pressure flow meter assembly comprising:
a conduit for conveying a flowable substance having a gas phase and a liquid phase there through in a given direction, said conduit having a peripheral wall with an interior surface;
a cone-shaped, fluid flow divergent displacement member including an upstream end and a downstream end relative to the direction of fluid flow, said member being of smaller size than said conduit and having a sloped wall forming a periphery on said member for deflecting said substance to flow through a region defined by said periphery of said displacement member and said interior surface of said conduit;
a first pressure measurement tap extending through the wall of said conduit and communicating with an area upstream of the displacement member;
a second pressure measurement tap extending through the wall of said conduit and through the displacement member, and communicating with an area at said downstream end of said displacement member;
a third pressure measurement tap extending through the wall of said conduit and communicating with an area downstream of the displacement member;
means for determining a first differential pressure value based on a pressure measurement taken from said first pressure measurement tap, and said second pressure measurement tap;
means for determining a second differential pressure value based on a pressure measurement taken from said second pressure measurement tap and said third pressure measurement tap; and
means for determining a gas flow rate for the gas phase of said substance and a liquid flow rate for the liquid phase of said substance using said first, and second differential pressure values in a manner that applies the relationship:
$${m}_{l} = {X}_{LM} ⋆ {m}_{g} ⋆ \sqrt{\frac{{ρ}_{l}}{{ρ}_{g}}}$$
where X_{LM} is represented by the relationship:
$${X}_{LM} = {( \frac{( φ - 1 )}{g ( \frac{{ρ}_{g}}{{ρ}_{l}} , {Fr}_{g} )} )}^{\frac{1}{\# B}}$$
with g determined by iteratively surface fitting the gas to liquid density ratio for the specific meter involved against Fr_{g} as represented by the relationship;
$$\begin{matrix}{Fr}_{g} = \sqrt{\frac{Superficial Gas Inertia}{Liquid Gravity Force}} \\ = \frac{{U}_{sg}}{\sqrt{gD}} \sqrt{\frac{{ρ}_{g}}{{ρ}_{l} - {ρ}_{g}}} \\ = \frac{{m}_{g}}{A \sqrt{gD}} \sqrt{\frac{1}{{ρ}_{g} ( {ρ}_{l} - {ρ}_{g} )}}\end{matrix}$$
with theta φ represented by the relationship:
$$\begin{matrix}φ = \frac{OR}{{OR}^{′}} \\ = \frac{{( \frac{{m}_{g , Apparent}}{{m}_{g}} )}_{Converging}}{{( \frac{{m}_{g , Apparent}}{{m}_{g}} )}_{Diverging}} \\ = \frac{{( {m}_{g , Apparent} )}_{Converging}}{{( {m}_{g , Apparent} )}_{Diverging}} \geq 1\end{matrix}$$
m_{g Converging} represented by the relationship:
(m_{g,Apparent})_{Converging}=EAₜεₜₚC_{dtp}\sqrt{2ρΔPₜₚ}
and m_{g Diverging} represented by the relationship:
(m_{g Apparent})_{Diverging}=EAₜKₜₚ*\sqrt{2ρΔPₜₚ*}
each use to then substitute in X_{LM} to the expansion cone meter wet gas correlation as expressed by the relationship:
$${OR}^{*} = \sqrt{\frac{Δ {P}_{tp}^{*}}{Δ {P}_{g}^{*}}} = \frac{1 + {A}^{′} X + {B}^{′} {Fr}_{g}}{1 + {C}^{′} X + {B}^{′} {Fr}_{g}} .$$

15. The flow meter assembly of claim 14, wherein said third flow measurement tap extends through said conduit at an area that is at least four diameters downstream from said displacement member.

16. The flow meter assembly of claim 14, wherein said third flow measurement tap extends through said conduit at an area that is six diameters downstream from said displacement member.

17. The flow meter assembly of claim 14, further comprising a support extending through said conduit that mounts said displacement member to said conduit and holds said displacement member in position in the fluid flow.

18. A method of determining flow rates of a two-phase fluid using a divergent displacement differential pressure flow meter including a cone-shaped divergent displacement member positioned within a conduit, a first pressure measurement tap positioned upstream from the cone-shaped displacement member, a second pressure measurement tap positioned at a downstream end of the cone-shaped displacement member and a third pressure measurement tap positioned downstream from the cone-shaped displacement member, said method comprising:
measuring a pressure of the fluid at each of the first pressure measurement tap, the second pressure measurement tap and the third pressure measurement tap;
determining a first differential pressure between the first pressure measurement tap, and the second pressure measurement tap;
determining a second differential pressure between the second pressure measurement tap and the third pressure measurement tap wherein two flow measurement taps used to determine said second differential pressure are different than said two flow measurement taps used to determine said first differential pressure;
determining a gas flow rate for the gas phase of said substance and a liquid flow rate for the liquid phase of said substance using said first, and second differential pressure values in a manner that applies the relationship:
$${m}_{l} = {X}_{LM} ⋆ {m}_{g} ⋆ \sqrt{\frac{{ρ}_{l}}{{ρ}_{g}}}$$
where X_{LM} is represented by the relationship:
$${X}_{LM} = {( \frac{( φ - 1 )}{g ( \frac{{ρ}_{g}}{{ρ}_{l}} , {Fr}_{g} )} )}^{\frac{1}{\# B}}$$
with g determined by iteratively surface fitting the gas to liquid density ratio for the specific meter involved against Fr_{g} as represented by the relationship:
$$\begin{matrix}{Fr}_{g} = \sqrt{\frac{Superficial Gas Inertia}{Liquid Gravity Force}} \\ = \frac{{U}_{sg}}{\sqrt{gD}} \sqrt{\frac{{ρ}_{g}}{{ρ}_{t} - {ρ}_{g}}} \\ = \frac{{m}_{g}}{A \sqrt{gD}} \sqrt{\frac{1}{{ρ}_{g} ( {ρ}_{t} - {ρ}_{g} )}}\end{matrix}$$
with theta φ represented by the relationship:
$$\begin{matrix}φ = \frac{OR}{{OR}^{′}} \\ = \frac{{( \frac{{m}_{g , Apparent}}{{m}_{g}} )}_{Converging}}{{( \frac{{m}_{g , Apparent}}{{m}_{g}} )}_{Diverging}} \\ = \frac{{( {m}_{g , Apparent} )}_{Converging}}{{( {m}_{g , Apparent} )}_{Diverging}} \geq 1\end{matrix}$$
with m_{g Converging} represented by the relationship:
(m_{g,Apparent})_{Converging}=EAₜεₜₚC_{dtp}\sqrt{2ρΔPₜₚ}
and m_{g Diverging} represented by the relationship:
(m_{g Apparent})_{Diverging}=EAₜKₜₚ*\sqrt{2ρΔPₜₚ*}
each use to then substitute in X_{LM} to the expansion cone meter wet gas correlation as expressed by the relationship:
$${OR}^{*} = \sqrt{\frac{Δ {P}_{lp}^{*}}{Δ {P}_{g}^{*}}} = \frac{1 + {A}^{′} X + {B}^{′} {Fr}_{g}}{1 + {C}^{′} X + {B}^{′} {Fr}_{g}} .$$
